(19) United States
(12) Patent Application Publication
(10) Pub. No.: US 2013/0073385 A1
(43) Pub. Date: Mar. 21, 2013

(54) COMMUNICATION METHOD AND SYSTEM FOR ONLINE AND OFFLINE SOCIAL COMMERCE

(71) Applicants: Bo Wu, Santa Clara, CA (US); Yuhong Xiong, Mountain View, CA (US)

(72) Inventors: Bo Wu, Santa Clara, CA (US); Yuhong Xiong, Mountain View, CA (US)

(73) Assignee: LaShou Group Inc.

(21) Appl. No.: 13/236,364

(22) Filed: Sep. 19, 2011

(51) Int. Cl. G06Q 30/00

(52) U.S. Cl. 705/14.51

(57) ABSTRACT

Computer-implemented methods, systems facilitating the methods, and computer-readable medium storing computer readable code, which, when executed, performs the methods are provided for online to offline social commerce services. The methods may include (1) receiving a request from a content provider to post a content including an advertisement of a item for sale, (2) causing display of the content to a designated group, (3) receiving a request from a user to purchase the item after reviewing the content, (4) receiving payment for the item from the user, and (5) informing the user that the purchase is executed. The content can be a blog message, wherein the designated group includes followers of the content provider's blog, or the content can be a game, wherein the designated group includes players of the game.

### FIELD OF DISCLOSURE

The present disclosure relates generally to a communication system and method for offer and sale of goods and services, and more particularly to the offer and sale of goods through an online social commerce platform.

### BACKGROUND

In retailing, a merchant typically advertises goods and/or services through a variety of channels. The advertising and marketing associated with goods and services can be expensive and ineffective when performed through radio, television, and print media. In conventional advertising methods, a merchant typically advertises to each individual directly, because consumers usually do not pass along the advertisements to others.

There is a need in the art to provide a more mutually satisfactory system and method to provide the consumer with a capability to receive reward for reposting the advertisement and/or commenting on the deal, goods, or the merchant for others to review, and at the same time providing the merchant with expense-free advertising and marketing for the goods or services.

### SUMMARY

According to one embodiment, a computer-implemented method is provided including: (1) receiving a request through a communications network from a content provider to provide content including an advertisement of a item for sale or a link to the advertisement of the item for sale, (2) causing display of the advertisement to a designated group, (3) receiving a request through said communications network from a user to purchase the item after reviewing the content, (4) receiving payment for the item from the user, and (5) informing the user that the purchase is executed. The content can be a blog message, wherein the designated group includes followers of the content provider's blog, or the content can be a game, wherein the designated group includes players of the game.

According to another embodiment, a system is provided including: a content posting module configured to receive a request from a content provider to post a content comprising an advertisement of a item for sale or a link to the advertisement of the item for sale, an content displaying module configured to cause display of the advertisement to a designated group, a purchase requesting module configured to receive a request from a user to purchase the item after reviewing the content, a payment receiving module configured to receive payment for the item from the user, and a deal informing module configured to inform the user that the purchase is executed.

According to another embodiment, a non-transitory computer-readable medium is provided storing computer readable code, which, when executed, performs the method described above.

These and other embodiments and advantages thereof will become more readily apparent from the attached drawings and the detailed description that follow.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1 illustrates an exemplary computer system according to one embodiment of the present invention.

FIG. 2 illustrates a flow chart according to a first non-limiting example of the present invention.

FIG. 3 illustrates a flow chart according to a second non-limiting example of the present invention.

FIGS. 4A-4F illustrate example web pages according to several non-limiting examples of the present invention.

### DETAILED DESCRIPTION

Following below are more detailed descriptions of various concepts related to, and embodiments of the above-described methods, systems and non-transitory computer-readable medium for implementing the methods. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

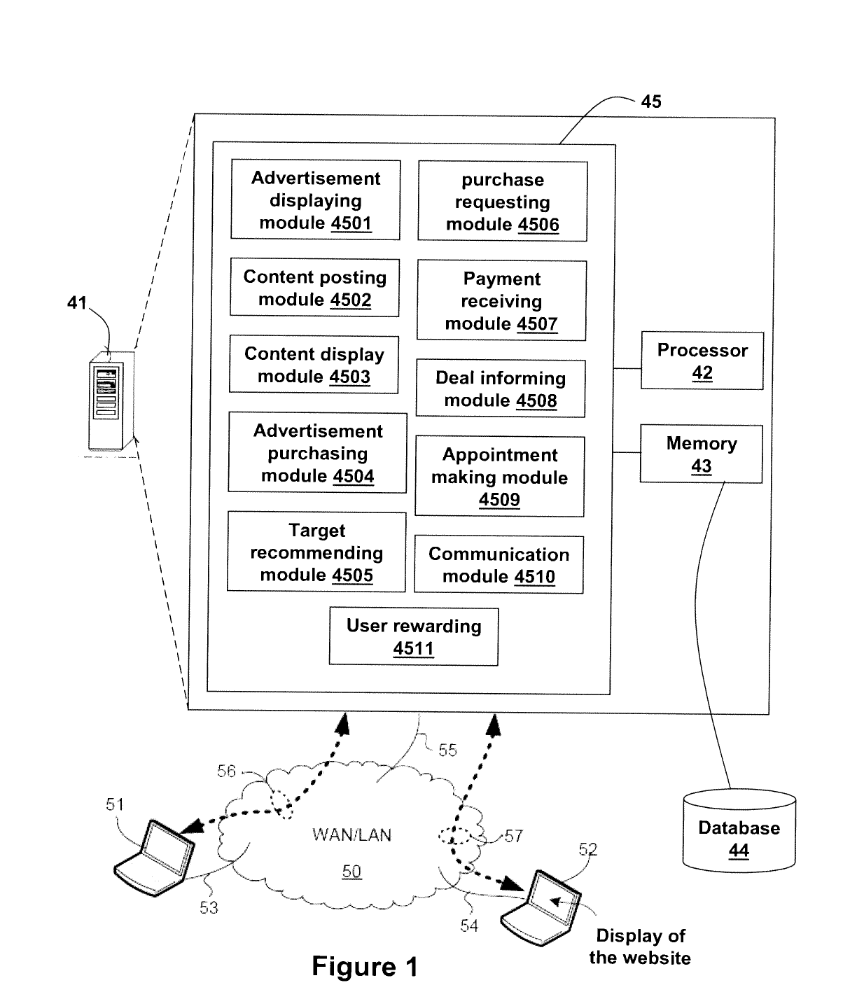

FIG. 1 illustrates an example system for implementing embodiments detailed below. As illustrated in FIG. 1, a system according to one embodiment of the present invention may comprise at least one server 41, a plurality of user devices such as a first user device 51, a second user device 52, and Internet, wide-area network (WAN), or local-area network (LAN) 50 that interconnects the server 41 and the plurality of user devices via wired or wireless communication links 53-55. The system may be used to provide an online to offline social commerce platform to the users and to merchants. For example, the users may utilize user devices to communicate with the server 41 for viewing advertisement, their reviews, forwarding request of providing contents regarding the advertisement, obtaining coupons, redeeming coupons and credits, and purchasing featured products. Any desired devices, such as cell phone, PDA, computer and other electronic devices that allow transmission of data to and from the server 41 may be used as the user devices.

The server 41 comprises a processor 42, a memory device 43 that connects to a permanent database 44, and a social commerce management module 45. The social commerce management module 45 comprises an advertisement displaying module 4501, a content posting module 4502, a content displaying module 4503, an advertisement purchasing module 4504, a target recommending module 4505, a purchase requesting module 4506, a payment receiving module 4507, and a deal informing module 4508, an appointment making module 4509, a communication module 4510 and a user rewarding module 4511.

The advertisement displaying module 4501 may be configured to cause display of an initial advertisement of an item. The item may be any product or service for sale. The content posting module 4502 may be configured to receive a request from a content provider to post a content comprising the advertisement or a link to the advertisement to be viewed by a designated group or general public. In some embodiments, the content may further comprise a comment on the deal. The content displaying module 4503 may be configured to cause display of the content provided by the content provider to general public or the designated group. The content provider may be any individual or entity who repost the advertisement, for example but not limited to a merchant of the item, a consumer of the item, advertisers such as e-commerce sites, or game providers. In some embodiments, the content can be a blog message. In these embodiments, the content may be set to be viewed by followers of the content provider's blog. In some other embodiments, the content can be a game, in which an advertisement is embedded.

An advertisement purchasing module 4504 may be configured to allow a merchant providing the item for sale or an advertiser to purchase an in-game advertisement place for advertising the item, an in-game coupon for awarding a winner of the game, or an advisement place in a product listing. When a merchant or advertiser choose to purchase an in-game advertisement place for advertising the item, the merchant or advertiser may be allowed to choose to display the advertisement to one or designated groups of game players. Similarly, when a merchant or advertiser choose to purchase an in-game coupon for awarding a winner of the game, the merchant or advertiser may be allowed to choose to award only one or designated groups of game players.

A target recommending module 4505 may be configured to recommend to the merchant or advertiser the one or more targeted groups. Particular targeted user groups may be identified by the system based on statistics of consumer studies or previous data collected by the system. Of course, the advertiser may also choose to display the advertisement to all game players.

The purchase requesting module 4506 may be configured to receive a request from a user to purchase the item after reviewing the content posted by the content provider via the content displaying module 4503 and/or the initial advertisement by an advertiser or merchant via the advertisement displaying module 4501. The payment receiving module 4507 may be configured to receive payment for the item from the user. Any suitable payment methods may be used, for example but not limited to credit card, debit card, Paypal, or RTM. At the same time (or shortly thereafter), the merchant would receive a payment based on a previous agreement between the merchant and the owner of the system for a portion of the sale of the item, after taking out the cost charged by the owner of the system.

The deal informing module 4508 may be configured to inform the user that the purchase is executed. The appointment making module 4509 may be configured to allow a user to make an appointment for redeeming the item.

The communication module 4510 may be configured to allow users to instantly communicate with the merchant or advertiser, before and/or after making a purchase. For example, the user may initiate an online-to-off line communication with a merchant representative by methods including but not limited to a click-to-call from the website, an online-to-offline short message, an on-line-to offline facsimile, or the like. Of course, the communication may also be facilitated by other methods, such as online chatting, email, off-line phone calls, or the like.

A user rewarding module 4511 can be configured to reward a content provider if any sales of the item have been originated from the content (e.g., a blog message or a game) provided by him. Alternatively or additionally, a user may also be rewarded if a predetermined level of activity is achieved. For example, when the number of postings/re-postings by a user reaches a certain number, the user gets some reward of virtual cash or real cash or coupon for redeeming some products or services.

Furthermore, a user may be rewarded if he successfully influences one or more other users to view the content and/or play the game. The reward can be determined based on an influence ranking of the user. For example, in some embodiments, users with a large number of followers can be considered as opinion leaders, and get more or better rewards when they re-post a deal. A user can have a rank or grade, which can be denoted by a score, or a number of stars/diamonds/crowns, or a number of levels (e.g., bronze, silver, gold) etc. Users with higher ranks or grades may be granted more privilege on the platform. For example, they may receive bigger discount when purchasing deals, or they may be awarded more expansive virtual goods in games, etc.

In some embodiments, a micro-blog based social network service (SNS) may be provided by the social commerce platform, where users can follow each other, re-post deals, make comments on deals, and respond to postings, etc. Group buying sites or merchants can also publish deals to the platform. In these embodiments, a user may be rewarded when he successfully invites a friend to join the SNS. The platform may also pull deals through open application program interfaces (APIs) published by the other sites.

In some embodiments, an open gaming platform is provided including in-game promotions. For example, game developers can publish and operate games on the platform, and commercials can be embedded in the game. Users can get rewarded from the people they influenced through social games. Content providers, like game developers, may also be awarded when their game facilitated sales.

The reward can be calculated through any desirable models for example but not limited to cost per sale (CPS), cost per action (CPA), cost per click (CPC), or cost for a predetermined level of impression (CPM). The CPM can be grouped as any number of impressions, for example as 1000 impressions. The reward can comprise at least one of virtual redeemable for purchase, or real cash.

The activities performed by the users and other information related to the repost, review, and purchase of the product/service may be saved by server 41 onto database 44, which can then be utilized for statistic analysis or other purposes.

The different modules within the social commerce management module 45 are function modules that interwork with each other. The function modules, when executed by processor 42, allow the system to effectively and efficiently manage the above-described social commerce activities. One or more of the function modules may be omitted, and additional modules may be added if needed. Communication messages (e.g., 56 and 57) may be exchanged between the server 41 and user devices 51-52, etc., via the Internet, wide-area network (WAN) or local-area network (LAN) 50.

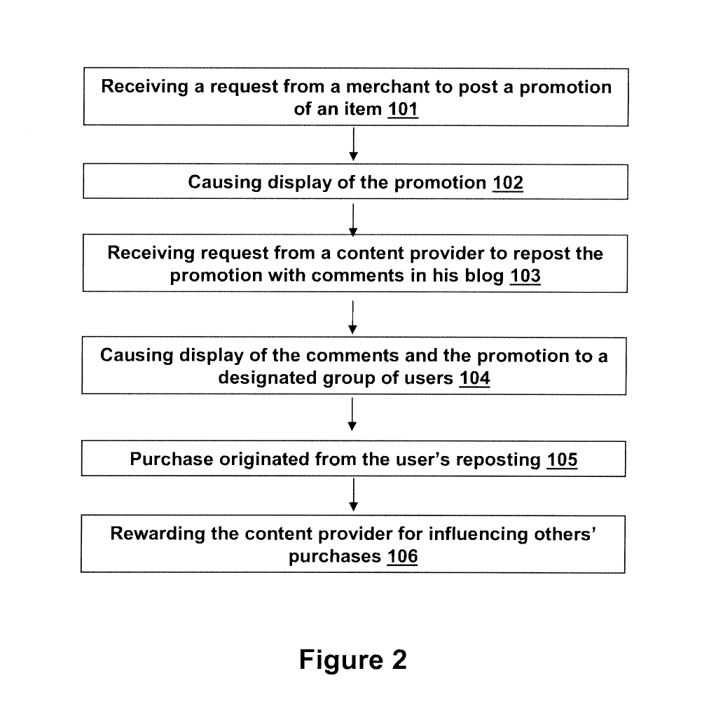

FIG. 2 illustrates a flow chart according to a first non-limiting example. First, at step 101, a request to post an advertisement of the item is received from a merchant or an advertiser by the server, which then at step 102 causes display of the promotion, either to general public or a designated group chosen by the merchant or advertiser of the item.

Next, at step 103, the system receives a request from a content provider to repost the advertisement in his blog. The repost may further include a comment on the merchant or the particular item for sale.

At step 104, such a blog message reporting the advertisement may be viewed by general public or a designated group such as followers of his blog or subgroups of his followers.

At step 105, users may be influenced by the content provider's re-posting/comments to review the specifics of the promotion or to purchase the item. At step 106, the content provider can then be rewarded for his influence on other users. The content provider may also be rewarded if a predetermined level of activity is achieved, for example re-posting promotions/comments for a certain number of times, etc. The reward can be virtual redeemable for purchase, or real cash. The reward can be calculated through a model selected from CPS, CPA, CPC, CPM, OR other desirable models.

If the user needs to contact the merchant before or after making a purchase, the user can instantly communicate with the merchant via online-to-offline communication. For example, the user may initiate a communication with a merchant representative by any suitable online-to-off line communication methods, for example but not limited to a click-to-call from the website, an online-to-offline short message, an on-line-to offline facsimile, or the like. The communication may also be facilitated by other methods, such as online chatting, email, off-line phone calls, or the like.

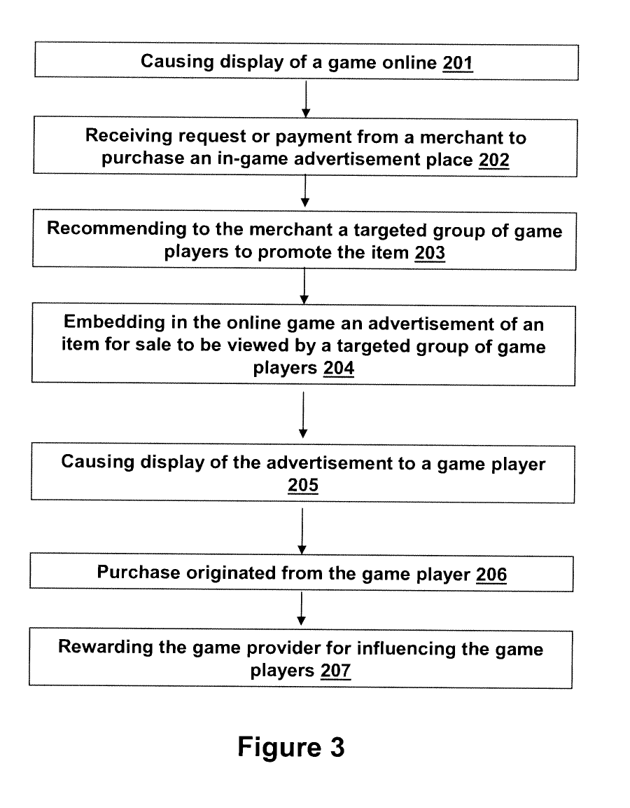

FIG. 3 illustrates a flow chart according to another non-limiting example. A promotion of an item for sale by a merchant through user game playing will be used in the following description for purpose of illustration. At step 201, a game provider provides an online game, which can be posted on a website. At step 202, a request to purchase an in-game advertisement place is received by the server. For example, the merchant or advertisers such as e-commerce sites can purchase an in-game advertisement place for advertising the item or an in-game coupon for awarding a user who wins a certain level of the game.

At step 203, the server may recommend the merchant, the e-commerce website provider, or other advertisers a targeted game player group to promote the item. Next, at step 204, the system can embed the advertisement or coupon in the game to promote the item for sale. In this non-limiting example, if the merchant, the e-commerce website provider or other advertisers choose to embed an advertisement of the item in the game to be viewed by a designated group of game player, e.g., male from 20-30 years old, such the advertisement of the item will be displayed when such game players play the game at step 205. If one or more of the game players is influenced by the advertisement embedded in the game (e.g., purchase the item, review the specifics of the item, or repost the advertisement, etc) at step 206, the game provider can then be rewarded at step 207. The reward to the game provider may be at least one of virtual cash redeemable for purchases or real cash. The reward can be calculated through any desirable models, for example but not limited to cost per sale (CPS), cost per action (CPA), cost per click (CPC), or cost for a predetermined level of impression (CPM). The CPM can be grouped as 1000 impressions, for example.

Alternatively, if the merchant, the e-commerce website provider or other advertisers choose to provide a coupon as an award to game winners of a predetermined level, the user will be awarded the coupon provided if he wins the predetermined level of the game. The game provider will then be rewarded if the user redeems the coupon for the item, or repost the advertisement of the item with or without a comment in his blog.

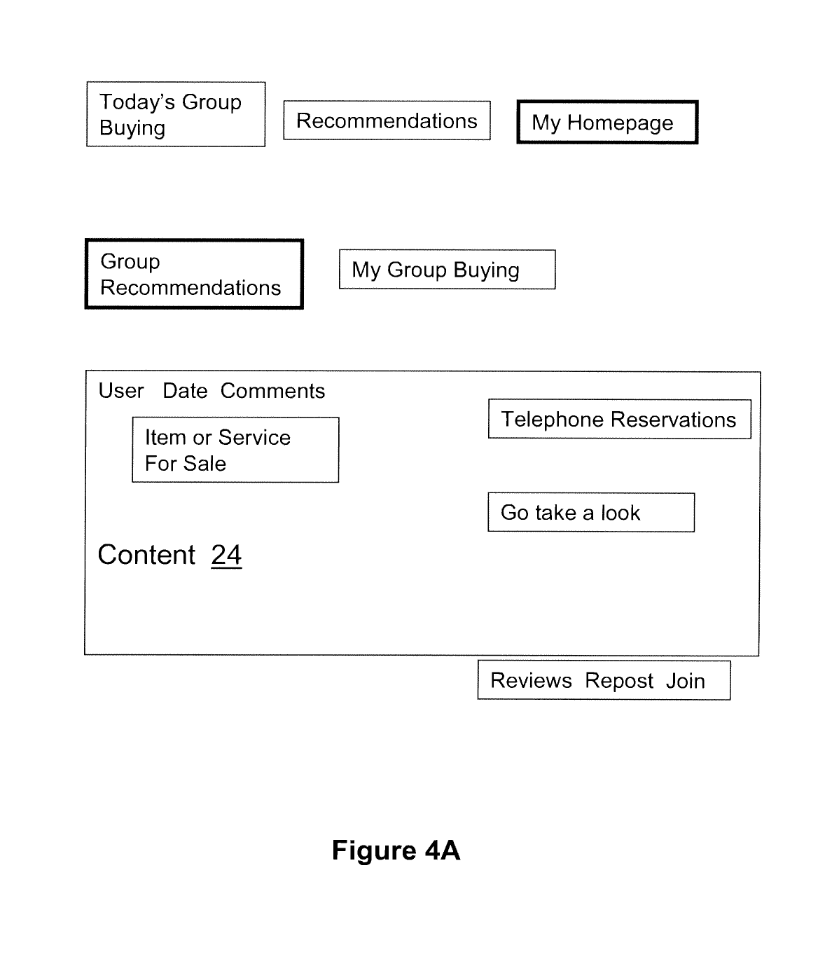

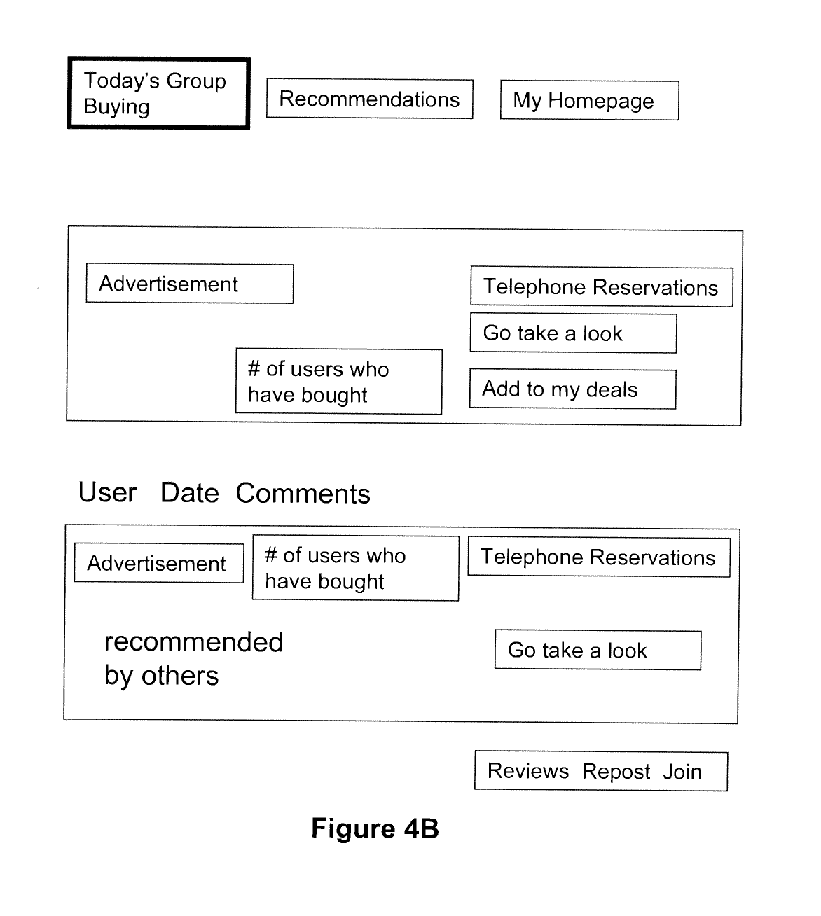

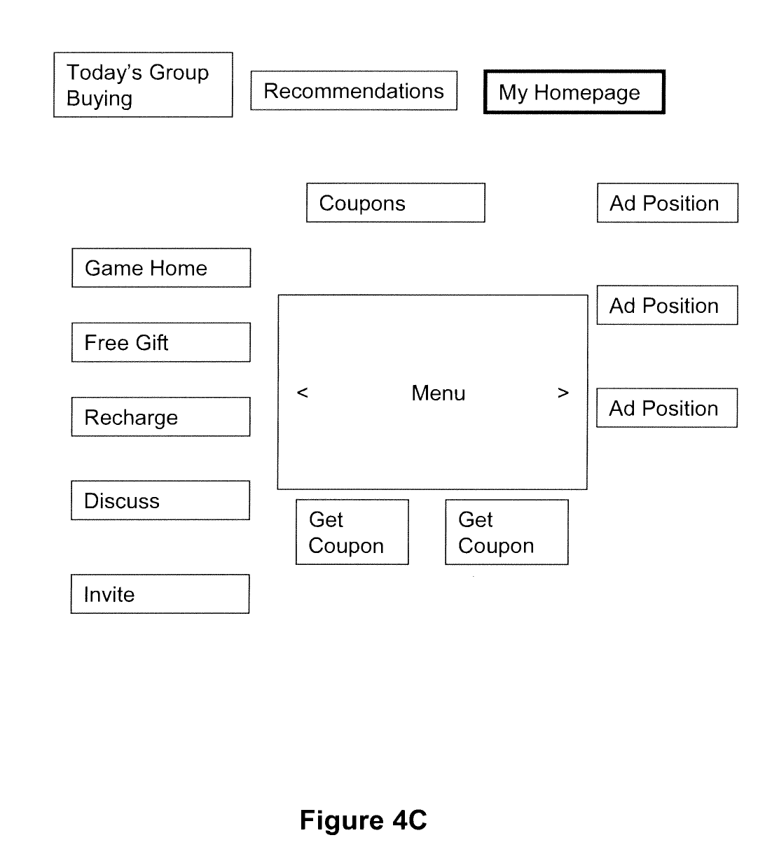

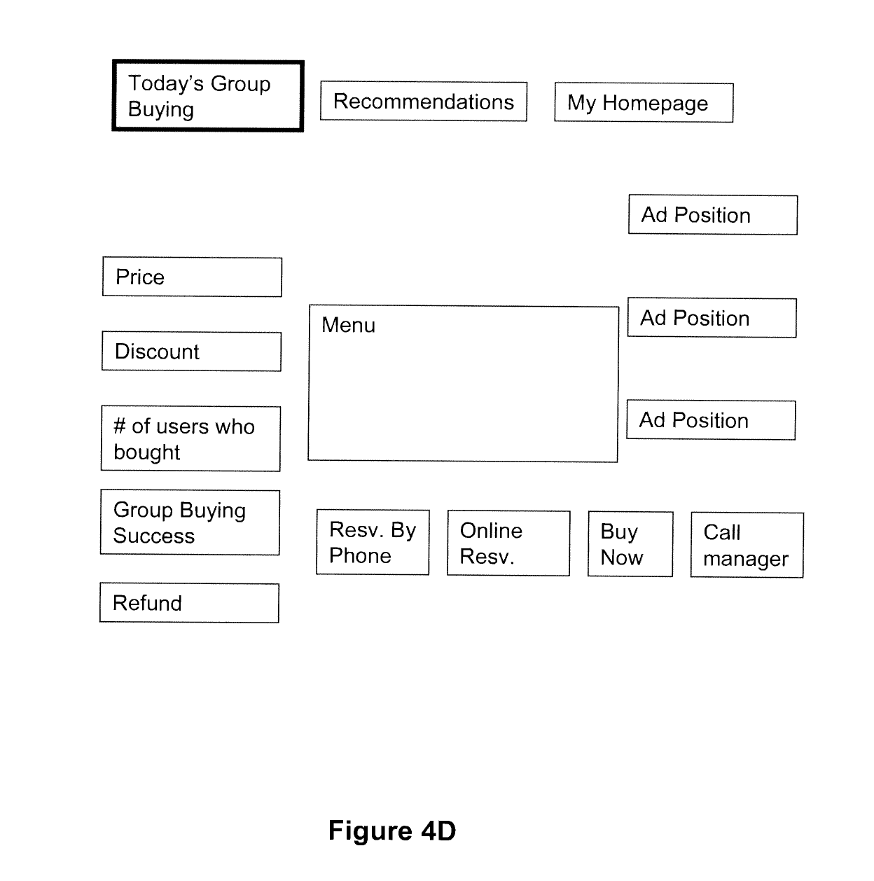

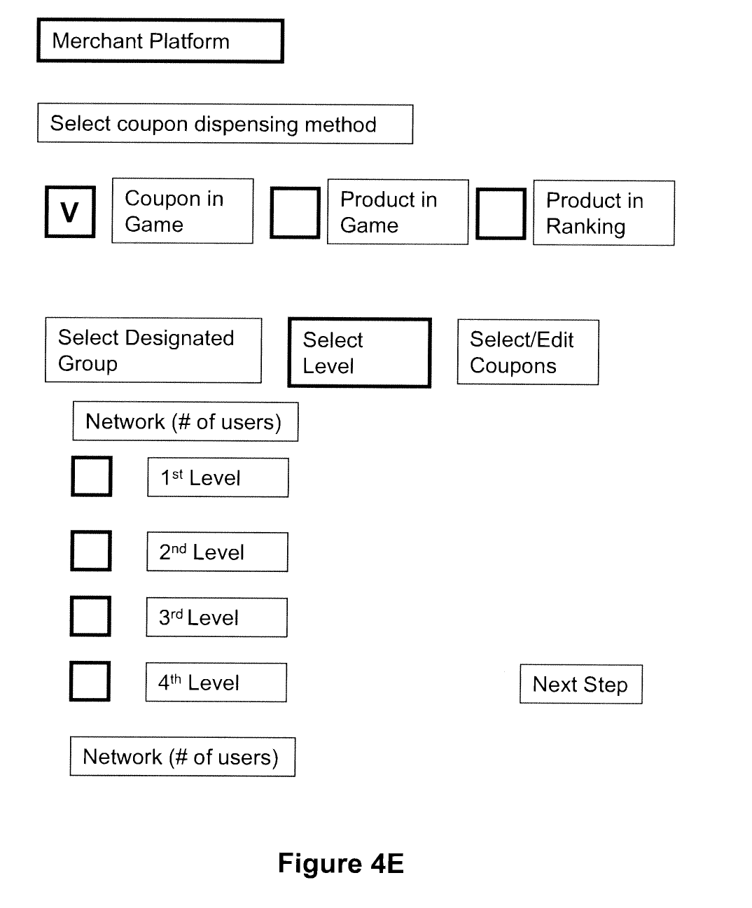

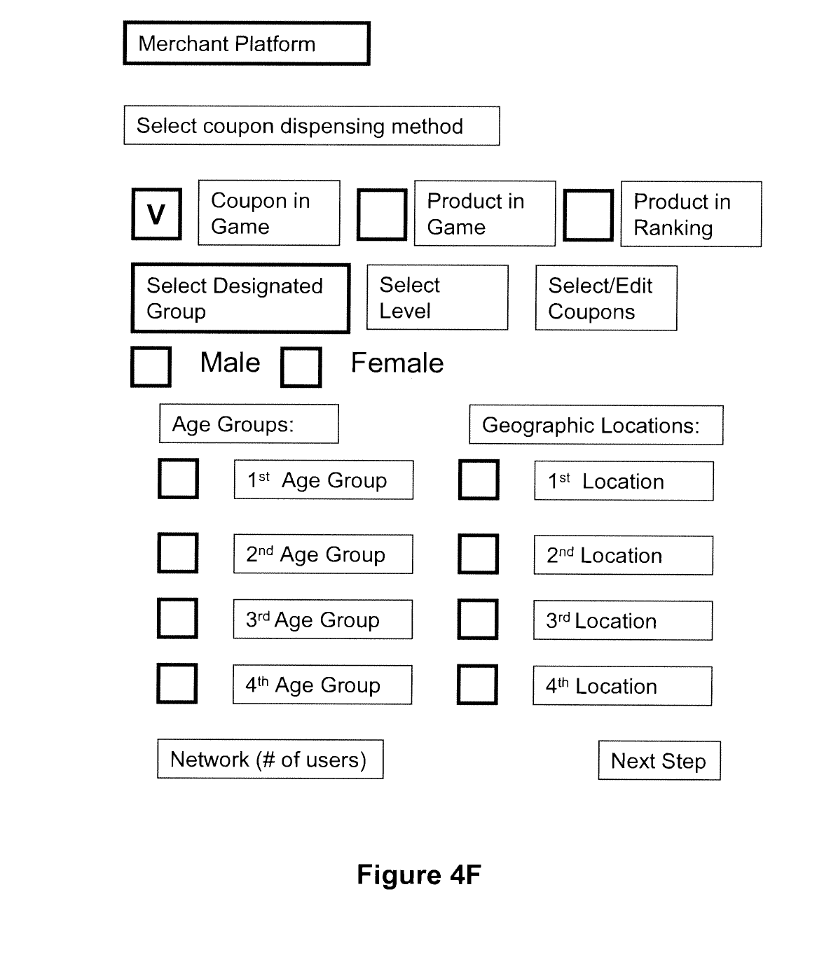

FIG. 4A is an example display of a webpage showing a content as shown in a user's homepage, where “Group Recommendations” are selected, showing recommendations from content providers. The content can further include a comment from the content providers (e.g., other consumers or the merchant) on the item for sale. The social commerce platform may allow the user to review comments regarding the item for sale provided by more than one content providers. In some embodiments, the user can be allowed to add selected deals to a page that contains all of his/her favorite deals.

The designated group may be the general public including a plurality of users. Alternatively, the designated group may be a particular group of users selected by any desirable factors for example but not limited to sex, age, geographical locations, or other characters/needs thereof. The content provider can be a merchant of the item, a consumer of the item, advertisers such as e-commerce sites, or game providers.

The advertisement of the item for sale may be first posted by the merchant providing the item for sale. Subsequently, a consumer of the item may become a content provider and re-posts the advertisement with the user's comments. For example, the social commerce platform may allow the user to re-post the advertisement of the item on the user's own blog with comments.

Referring now to FIG. 4B, the social commerce website owner can choose to post a list of “featured deals” or “today's deals.” In addition, the webpage may include a list of “recommended by others” posted by content providers, which the reviewers follow.

The website owner may choose to display the same list of featured deals for everyone, or personalize the list based on a recommender system. In some embodiments, the user name of the content provider (“User” tab in FIG. 4B) and an one line reason of the recommendation are shown with each deal. For example, the comment can be shown when the user name is clicked.

FIG. 4C is an example webpage for a user showing a menu of products or services that can be purchased, together with available games for play. A coupon for purchasing an item may be awarded to a game player who he wins the game, or a predetermined level of the game.

A user can instantly communicate with a merchant providing the item before and/or after making a purchase, through a communication channel. The communication can be facilitated by at least one of: an off-line phone call, a short message, an email, a facsimile, or chat made on-line to the merchant. The online calling can be made, for example, using “Skype©” or other click-to-call web applications. In some embodiments, the communication channel includes an online-to-offline (O2O) connection, where the user can directly connect to the merchant by one-click calling, or make reservation on the site.

FIG. 4D illustrates “Today's Group Buying” page for a user. Clickable tabs, such as “reservation by phone,” and “call manager,” are provided. By clicking these tabs, offline calls can be made, thus realizing online-to-offline communications.

In a merchant backend, merchants can log onto the platform to publish deals, and/or to log onto the platform to buy in-game advertisement space. With reference to FIG. 4E, the social commerce network provide a merchant with a Merchant's platform/backend, allowing the merchant purchase an in-game advertisement place for advertising or displaying a promotion of the item (e.g., product in game), an in-game coupon for awarding a user (e.g., coupon in game), or an advisement place in a product listing (e.g., product in ranking).

As illustrated in FIG. 4F, the merchant can select one or more levels of users. Furthermore, the “Select Designated Group” page of the merchant's platform may allow the merchant to select a targeted user group, by one or more factors for example but not limited to sex, age, geographical locations, or other user characteristics/needs to promote the item. Particular targeted user groups may be recommend to the merchant by the system based on statistics of consumer study or data collected by the system.

The functions and modules described above may be implemented in hardware, software, firmware, or any combinations thereof. If implemented in software, the functions may be stored on or transmitted over as one or more instructions or code on a computer readable (processor-readable) medium. Computer-readable media include both computer storage media and communication media including any medium that facilitates transfer of a computer program from one place to another. A storage media may be any available media that can be accessed by a computer or similar devices. By way of example, and not limitation, such computer-readable media can comprise RAM, ROM, EEPROM, CDROM or other optical disk storage, magnetic disk storage or other magnetic storage devices, or any other medium that both can be used to carry or store desired program code in the form of instructions or data structures, and can be accessed by a computer or similar devices. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

The computer readable code, when executed, performs the methods described above. For example, the methods include (1) receiving a request from a content provider to post a content including an advertisement of a item for sale, (2) causing display of the content to a designated group, (3) receiving a request from a user to purchase the item after reviewing the content, (4) receiving payment for the item from the user, and (5) informing the user that the purchase is executed. The content can be a blog message, wherein the designated group includes followers of the content provider's blog, or the content can be a game, wherein the designated group includes players of the game.

The above-described embodiments and examples are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

What is claimed is:

1. A computer-implemented method, comprising:
receiving a request through a communications network from a content provider to provide content comprising an advertisement of a item for sale or a link to the advertisement of the item for sale;
causing display of the content to a designated group through said communications network;
receiving a request through said communications network from a user to purchase the item after reviewing the content;
receiving payment for the item from the user; and
informing the user that the purchase is executed,
wherein the content comprises at least one of:
(a) a blog message, wherein the designated group includes followers of the content provider's blog, or
(b) a game, wherein the designated group includes players of the game.

2. The computer-implemented method of claim 1, wherein the content further comprises a comment on the item for sale.

3. The computer-implemented method of claim 2, further comprising allowing the user to review comments regarding the item for sale provided by one or more content providers.

4. The computer-implemented method of claim 1, wherein the content provider is a merchant providing the item for sale or an e-commerce site.

5. The computer-implemented method of claim 1, wherein:
the advertisement of the item for sale is first posted by a merchant providing the item for sale; and
the content provider is a consumer of the item who re-posts the advertisement with comments.

6. The computer-implemented method of claim 1, wherein the content is posted to the user's own blog and comprise the user's comments in addition to the advertisement of the item or the link to the advertisement of the item.

7. The computer-implemented method of claim 1, further comprising allowing a merchant providing the item for sale or an advertisement to purchase an in-game advertisement place for advertising the item, an in-game coupon for awarding a winner of the game, or an advisement place in a product listing

8. The computer-implemented method of claim 7, wherein the content is a game, and wherein the merchant or advertiser are allowed to select one or more targeted groups of the game players to promote the item.

9. The computer-implemented method of claim 8, further comprising recommending to the merchant or advertiser the one or more targeted groups.

10. The computer-implemented method of claim 1, further comprising allowing a user to instantly communicate with a merchant providing the item for sale before and/or after making a purchase.

11. The computer-implemented method of claim 10, wherein the communication is facilitated by at least one of an off-line phone call, a short message, an email, a facsimile, or chat made on-line to the merchant.

12. The computer-implemented method of claim 1, further comprising rewarding the content provider if any sales of the item have been originated from the blog message or the game.

13. A system, comprising:
an content posting module executed with one or more computer processors configured to receive a request from a content provider to post a content comprising an advertisement of a item for sale or a link to the advertisement of the item for sale;
an content displaying module executed with said one or more computer processors configured to cause display of the content to a designated group;
a purchase requesting module with said one or more computer processors configured to receive a request from a user to purchase the item after reviewing the content;
a payment receiving module with said one or more computer processors configured to receive payment for the item from the user; and
a deal informing module with said one or more computer processors configured to inform the user that the purchase is executed,
wherein the content comprises at least one of:
(a) a blog message, wherein the designated group includes followers of the content provider's blog, or
(b) a game, wherein the designated group includes players of the game.

14. The system of claim 13, wherein the content further comprises a comment on the item for sale.

15. The system of claim 14, further comprising a comments displaying module configured to display to the user comments regarding the item for sale provided by one or more content providers.

16. The system of claim 13, wherein the content provider is a merchant providing the item for sale or an e-commerce site.

17. The system of claim 13, wherein:
the advertisement of the item for sale is first posted by a merchant providing the item for sale; and
the content provider is a consumer of the item who re-posts the advertisement with comments.

18. The system of claim 13, wherein the content is posted to the user's own blog and comprise the user's comments in addition to the advertisement of the item or the link to the advertisement of the item.

19. The system of claim 13, further comprising an advertisement purchasing module configured to allow a merchant providing the item for sale or an advertiser to purchase an in-game advertisement place for advertising the item, an in-game coupon for awarding a winner of the game, or an advisement place in a product listing.

20. The system of claim 19, wherein the content is a game, and wherein the merchant or advertiser are allowed to select one or more targeted groups of the game players to promote the item.

21. The system of claim 20, further comprising a target recommending module configured to recommend to the merchant or advertiser the one or more targeted groups.

22. The system of claim 13, further comprising a communication module configured to allow a user to instantly communicate with a merchant providing the item for sale before and/or after making a purchase.

23. The system of claim 22, wherein the communication is facilitated by at least one of an off-line phone call, a short message, an email, a facsimile, or chat made on-line to the merchant.

24. The system of claim 13, further comprising a user rewarding module configured to reward the content provider if any sales of the item have been originated from the blog message or the game.

25. A non-transitory computer-readable medium storing computer readable code, which, when executed, performs a method comprising:
receiving a request from a content provider to post a content comprising an advertisement of a item for sale;
causing display of the content to a designated group;
receiving a request from a user to purchase the item after reviewing the content;
receiving payment for the item from the user; and
informing the user that the purchase is executed,
wherein the content comprises at least one of:
(a) a blog message, wherein the designated group includes followers of the content provider's blog, or
(b) a game, wherein the designated group includes players of the game.
